(19) United States
(12) Patent Application Publication
(10) Pub. No.: US 2023/0222068 A1
(43) Pub. Date: Jul. 13, 2023

(54) SYSTEM AND METHOD FOR OPTIMIZING CACHED MEMORY COMPRISING VARYING DEGREES OF SLA AND CRG

(71) Applicant: Flipkart Internet Private Limited, Bengaluru (IN)

(72) Inventor: Bageshwar Pratap NARAIN, Lucknow (IN)

(73) Assignee: Flipkart Internet Private Limited, Bengaluru (IN)

(21) Appl. No.: 17/715,454

(22) Filed: Apr. 7, 2022

(30) Foreign Application Priority Data
Jan. 11, 2022 (IN) 202241001363

(51) Int. Cl. G06F 12/0897; G06F 12/0815; G06F 12/0813

(52) U.S. Cl. CPC G06F 12/0897; G06F 12/0815; G06F 12/0813

(57) ABSTRACT

A system and method for optimizing cached memory comprising varying degrees of Service Level Agreements (SLA) and Consistency Requirement Grades (CRG). The system receives one or more requests from one or more client devices to store information in a cache memory, and determines degrees of Service Level Agreement (SLA) and CRG in the information received via requests or system configurations. Further, system stores for one-time in cache layer of cache memory, the information as master record, based on determining the degrees of SLA and CRG. Furthermore, the system stores grades of entries of information referencing to the master record in different layers of cache memory. Each of the grades of entries comprises different Time-To-Live (TTL). Thereafter, the system outputs the information stored in the master record to client devices, based on SLA and consistency requirements.

### FIELD

The embodiments of the present disclosure generally relate to managing content on a cache memory. More particularly, the present disclosure relates to a system and a method for optimizing cached memory comprising varying degrees of Service Level Agreements (SLA) and Consistency Requirement Grades (CRG).

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Generally, a cache memory may include a system that transparently stores data so that a future request for the data can be served faster. For instance, a cache memory can include a block of memory for temporary storage (e.g., such as CPU's, hard drives, and servers). In some instances, a service provider providing a variety of distributed applications can utilize one or more database servers that can each contain a plurality of database instances. To increase the speed of responding to requests in a request processing system, cache memory may be used. For example, cache memory may be used to store content items or pieces of content items. However, cache memory may be limited by the size of the memory available to the cache and how efficiently the cache memory stores, selects, and retrieves information.

Currently, distributed applications (e.g., web applications/mobile applications) to have increasing capabilities. The distributed application may include an application (e.g., computer-readable instructions) that is executed on multiple machines (e.g., a client and a server) in a network. For instance, distributed applications can use client-side code, have dynamic content, and/or the content can reach the distributed application from the client in a number of different ways. For example, content can reach the distributed application using Hypertext Transfer Protocol (HTTP), such as using push technology, and/or Asynchronous JavaScript and eXtensible markup language (AJAX) calls. The distributed applications can, for example, provide standardized data manipulation through the infrastructure of the network (e.g., database and/or server) including a thread pool and the cache store. The distributed applications (e.g., web applications/mobile applications) can be used by entities to implement business processes. In some instances, a service provider can provide a variety of distributed applications to a variety of customers (e.g., entities and/or clients). Such distributed application can be a factor in the operation success of the entity. As such, the service provider may have an interest in ensuring that the distributed applications operate properly and efficiently for their customers/clients (e.g., the entities and/or clients). Further, a cache layer may be between client and the application, with an important distinction, where the same information may be cached with different Time to Live (TTLs). Conventional systems may store duplicate copies of the same data in the cache store, which may not be memory efficient. Conventional system may not allow caching data for different clients, based on optimizing Central Processing Unit (CPU)/memory/network, each having a specific tolerance towards latency and consistency.

Therefore, there is a need to provide method and system for solving the shortcomings of the current technologies, by providing a system and a method for optimizing cached memory comprising varying degrees of Service Level Agreements (SLA) and Consistency Requirement Grades (CRG).

### SUMMARY

This section is provided to introduce certain objects and aspects of the present invention in a simplified form that are further described below in the detailed description. This summary is not intended to identify the key features or the scope of the claimed subject matter. In order to overcome at least a few problems associated with the known solutions as provided in the previous section, an object of the present invention is to provide a technique that may for undertake a transaction in a Three-Dimensional (3D) interactive environment.

It is an object of the present disclosure to provide a system and a method for optimizing cached memory comprising varying degrees of Service Level Agreements (SLA) and Consistency Requirement Grades (CRG).

It is another object of the present disclosure to provide memory optimized cache memory to serve client devices with varying degrees of SLA and consistency requirements (grades).

It is yet another object of the present disclosure to improve Central Processing Unit (CPU)/network performance of cache memory due to lower data transfer to the external cache memory.

It is an object of the present disclosure to enable the data in cache stored at a single place of the cache memory, considered as the master record, while configured “grades” of cache data have a reference to the master record, and different TTL defined on the cache data.

It is another object of the present disclosure to ensure the data being served cache memory to the client device is fresh, by setting a high consistency grade master record to low Time to Live (TTL).

It is another object of the present disclosure to ensure data is served for longer time, from cache memory to client device with lower consistency requirements, or stricter deadline requirements, even though the data can be stale, by setting a higher TTL to the master record.

It is another object of the present disclosure to help a microservice cache memory response in an efficient manner for different types of client devices.

In an aspect, the present disclosure a system for optimizing cached memory comprising varying degrees of Service Level Agreement (SLA) and Consistency Requirement Grades (CRG). The system receives one or more requests from one or more client devices to store information in a cache memory. The system determines degrees of Service Level Agreement (SLA) and consistency requirement grades in the information received via one or more requests or system configurations. Further, the system stores for one-time in a cache layer of the cache memory, the information as a master record, based on determining the degrees of SLA and consistency requirement grades. Furthermore, the system stores one or more grades of entries of the information referencing to the master record in different layers of the cache memory. Each of the one or more grades of entries comprises different Time-To-Live (TTL). Thereafter, the system outputs the information stored in the master record to the one or more client devices, based on the SLA and the consistency requirements.

In an embodiment, one or more requests is received from the one or more client devices via at least one of applications, browsers, platforms, and plugins. In an embodiment, the master record includes maximum TTL which includes TTLs of the one or more entries.

In an embodiment, the consistency requirement including a high consistency grade record includes low TTL for outputting updated information to the one or more client devices.

In an embodiment, the consistency requirement comprising a lower consistency grade record, or stricter deadline requirements, includes a higher TTL for outputting information for longer to the one or more client devices, even though the information is stale.

In an embodiment, the master record and the one or more entries comprises row Identity (ID), value, and the TTL.

In another aspect, the present disclosure a method for optimizing cached memory comprising varying degrees of Service Level Agreement (SLA) and Consistency Requirement Grades (CRG). The method includes receiving one or more requests from one or more client devices to store information in a cache memory. Further, the method includes determining degrees of Service Level Agreement (SLA) and consistency requirement grades in the information received via one or more requests or system configurations. Further, the method includes storing for one-time in a cache layer of the cache memory, the information as a master record, based on determining the degrees of SLA and consistency requirement grades. Thereafter, the method includes storing one or more grades of entries of the information referencing to the master record in different layers of the cache memory. Each of the one or more grades of entries comprises different Time-To-Live (TTL). Further, the method includes outputting the information stored in the master record to the one or more client devices, based on the SLA and the consistency requirements.

### BRIEF DESCRIPTION OF THE DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry/sub components of each component. It will be appreciated by those skilled in the art that invention of such drawings includes the invention of electrical components, electronic components or circuitry commonly used to implement such components.

FIG. 1 illustrates an exemplary block diagram representation of a network architecture implementing a proposed system for optimizing cached memory comprising varying degrees of Service Level Agreement (SLA) and Consistency Requirement Grades (CRG), according to embodiments of the present disclosure.

FIG. 2A illustrates an exemplary detailed block diagram representation of the proposed system, according to embodiments of the present disclosure.

FIG. 2B illustrates an exemplary schematic representation of exemplary scenario which includes clients with varying levels of consistency and Service Level Agreement (SLA) requirements, according to embodiments of the present disclosure.

FIG. 3 illustrates a flow chart depicting method of optimizing cached memory comprising varying degrees of Service Level Agreement (SLA) and Consistency Requirement Grades (CRG), according to embodiments of the present disclosure.

FIG. 4 illustrates a hardware platform for implementation of the disclosed system according to embodiments of the present disclosure.

The foregoing shall be more apparent from the following more detailed description of the invention.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, “connect”, “configure”, “couple” and its cognate terms, such as “connects”, “connected”, “configured” and “coupled” may include a physical connection (such as a wired/wireless connection), a logical connection (such as through logical gates of semiconducting device), other suitable connections, or a combination of such connections, as may be obvious to a skilled person.

As used herein, “send”, “transfer”, “transmit”, and their cognate terms like “sending”, “sent”, “transferring”, “transmitting”, “transferred”, “transmitted”, etc. include sending or transporting data or information from one unit or component to another unit or component, wherein the content may or may not be modified before or after sending, transferring, transmitting.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Embodiments of the present disclosure provides a system and a method for optimizing cached memory comprising varying degrees of Service Level Agreements (SLA) and Consistency Requirement Grades (CRG). The present disclosure provides memory optimized cache memory to serve client devices with varying degrees of SLA and consistency requirements (grades). The present disclosure improves Central Processing Unit (CPU)/network performance of cache memory due to lower data transfer to the external cache memory. The present disclosure enables the data in cache stored at a single place of the cache memory, considered as the master record, while configured “grades” of cache data have a reference to the master record, and different TTL defined on the cache data. The present disclosure ensures the data being served cache memory to the client device is fresh, by setting a high consistency grade master record to low Time to Live (TTL). The present disclosure ensures data is served for longer time, from cache memory to client device with lower consistency requirements, or stricter deadline requirements, even though the data can be stale, by setting a higher TTL to the master record. The present disclosure helps a microservice cache memory response in an efficient manner for different types of client devices.

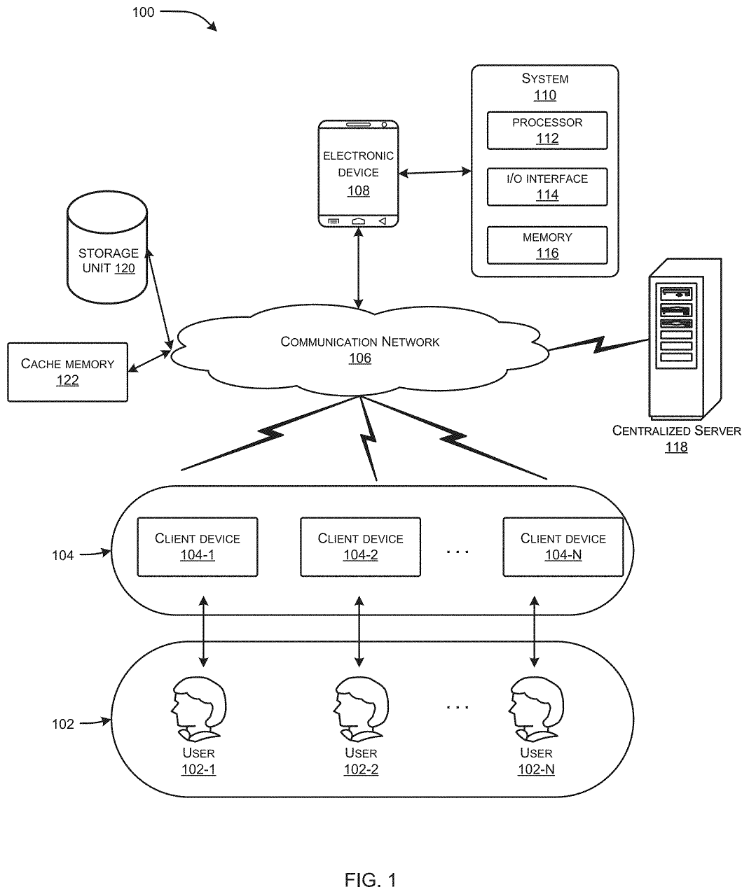

FIG. 1 illustrates an exemplary block diagram representation of a network architecture 100 implementing a proposed system 110 for optimizing cached memory comprising varying degrees of Service Level Agreement (SLA) and Consistency Requirement Grades (CRG), according to embodiments of the present disclosure. The network architecture 100 may include the system 110, an electronic device 108, and a centralized server 118. The system 110 may be connected to the centralized server 118 via a communication network 106. The centralized server 118 may include, but are not limited to, a stand-alone server, a remote server, cloud computing server, a dedicated server, a rack server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof, and the like. The communication network 106 may be a wired communication network or a wireless communication network. The wireless communication network may be any wireless communication network capable to transfer data between entities of that network such as, but are not limited to, a carrier network including circuit switched network, a public switched network, a Content Delivery Network (CDN) network, a Long-Term Evolution (LTE) network, a Global System for Mobile Communications (GSM) network and a Universal Mobile Telecommunications System (UMTS) network, an Internet, intranets, local area networks, wide area networks, mobile communication networks, combinations thereof, and the like.

The system 110 may be implemented by way of a single device or a combination of multiple devices that may be operatively connected or networked together. For instance, the system 110 may be implemented by way of standalone device such as the centralized server 118, and the like, and may be communicatively coupled to the electronic device 108. In another instance, the system 110 may be implemented in/associated with the electronic device 108. In yet another instance, the system 110 may be implemented in/associated with respective client device 104. In this scenario, the system 110 may be replicated in each of the client devices 104. The electronic device 108 may be any electrical, electronic, electromechanical and computing device. The electronic device 108 may include, but are not limited to, a mobile device, a smart phone, a Personal Digital Assistant (PDA), a tablet computer, a phablet computer, a wearable device, a Virtual Reality/Augment Reality (VR/AR) device, a laptop, a desktop, server, and the like. The system 110 may be implemented in hardware or a suitable combination of hardware and software. Further, the system 110 may include a processor 112, an Input/Output (I/O) interface 114, and a memory 116. The Input/Output (I/O) interface 114 on the system 110 may be used to receive one or more requests from one or more client devices 104-1, 104-2, 104-N (collectively referred as client devices 104 and individually referred as client device 104) to store information in a cache memory 122, based on accessing/executing one or more applications/web pages/webs sites by one or more users 102 (collectively referred as users 102 and individually referred as user 102) on respective client device 104. Further, the network architecture 100 may include storage unit 120. Such storage unit may comprise non-volatile and/or volatile memory. Non-volatile memory includes, for example, optical disks, magnetic disks, or solid-state drives. Volatile memory includes dynamic memory. Common forms of storage unit may include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

The storage unit 120 may also be a database server which may include one or more storage database instances. The storage database, as used herein, can be used as a cache store for thread pooling and storing query definitions and results (e.g., thereby, the cache store contained on a storage database, as used herein, may not be stored in memory). One or more of the storage units 120 may include primary storage databases. A primary storage database, as used herein, can include an active cache store that a user 102 (e.g., a client device 104) can access and perform read and write operations against it (e.g., can receive un-expired data from the cache store). In some instances, a separate server in the network can contain a secondary storage database. A secondary storage database can include a passive cache store that can contain a replicated and/or mirrored copy of data contained in the active cache store. In some instance, the storage unit 120 may be associated with an application/web page/website, and the like. A storage unit associated with an application/web page/website can include, for instance, a database containing data associated with the application/web page/website. The storage unit 120 in one or more embodiments, can include a Configuration Management Database (CMBD), a Structured Query Language (SQL) database, and/or distributed databases, among other databases.

In an instance, the storage unit 120, and the cache memory 122 may be implemented or associated with electronic device 108 and/or system 110. In another instance, the storage unit 120, and the cache memory 122 may be implemented via communication network 106 as shown in FIG. 1.

Further, the system 110 may also include other units such as a display unit, an input unit, an output unit and the like, however the same are not shown in the FIG. 1, for the purpose of clarity. Also, in FIG. 1 only few units are shown, however the system 110 or the network architecture 100 may include multiple such units or the system 110/network architecture 100 may include any such numbers of the units, obvious to a person skilled in the art or as required to implement the features of the present disclosure. The system 110 may be a hardware device including the processor 112 executing machine-readable program instructions to optimizing cached memory comprising varying degrees of Service Level Agreement (SLA) and Consistency Requirement Grades (CRG). Execution of the machine-readable program instructions by the processor 112 may enable the proposed system 110 to optimizing cached memory comprising varying degrees of Service Level Agreement (SLA) and Consistency Requirement Grades (CRG). The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processor 112 may include, for example, but are not limited to, microprocessors, microcomputers, microcontrollers, digital signal processors, central processing units, state machines, logic circuits, any devices that manipulate data or signals based on operational instructions, and the like. Among other capabilities, the processor 112 may fetch and execute computer-readable instructions in the memory 116 operationally coupled with the system 110 for performing tasks such as data processing, input/output processing, and/or any other functions. Any reference to a task in the present disclosure may refer to an operation being or that may be performed on data.

In the example that follows, assume that a user 102 of the system 110 desires to improve/add additional features optimizing cached memory comprising varying degrees of Service Level Agreement (SLA) and Consistency Requirement Grades (CRG). In this instance, the user may include an administrator of a website, an administrator of an e-commerce site, an administrator of a social media site, an administrator of an e-commerce application/social media application/other applications, an administrator of media content (e.g., television content, video on demand content, online video content, graphical content, image content, augmented/virtual reality content, meta verse content), among other examples, and the like. The system 110 when associated with the electronic device 108 or the centralized server 118 may include a touch panel, a soft keypad, a hard keypad (including buttons) and the like. For example, the user may click a soft button on a touch panel of the electronic device 108 or the centralized server 118 to browse/shop/perform other activities. In a preferred embodiment, the system 110 via the electronic device 108 or the centralized server 118 may be configured to receive a request from the user via a graphical user interface on the touch panel. As used herein, the graphical user interface may be a user interface that allows a user of the system 110 to interact with the system 110 through graphical icons and visual indicators, such as secondary notation, and any combination thereof, and may comprise of a touch panel configured to receive an input using a touch screen interface.

In an embodiment, the system 110 may receive one or more requests from one or more client devices 104 to store information in the cache memory 122. The one or more requests is received from the one or more client devices via at least one of applications, browsers, platforms, and plugins. Further, the system 110 may determine degrees of Service Level Agreement (SLA) and consistency requirement grades in the information received via one or more requests or system configurations. The information is passed in the request explicitly or derived implicitly based on the system configurations. Further, the system 110 may store for one-time in a cache layer of the cache memory, the information as a master record, based on determining the degrees of SLA and consistency requirement grades. Storing includes allocating a space in the cache memory 122 for the master record. The consistency requirement including a high consistency grade record includes low TTL for outputting updated information to the one or more client devices. The consistency requirement including a lower consistency grade record, or stricter deadline requirements, includes a higher TTL for outputting information for longer to the one or more client devices, even though the information is stale.

Further, the system 110 may store one or more grades of entries of the information referencing to the master record in different layers of the cache memory. Each of the one or more grades of entries comprises different Time-To-Live (TTL). The master record includes maximum TTL which includes TTLs of the one or more entries. The master record and the one or more entries includes row Identity (ID), value, and the TTL. Thereafter, the system 110 may output the information stored in the master record to the one or more client devices, based on the SLA and the consistency requirements.

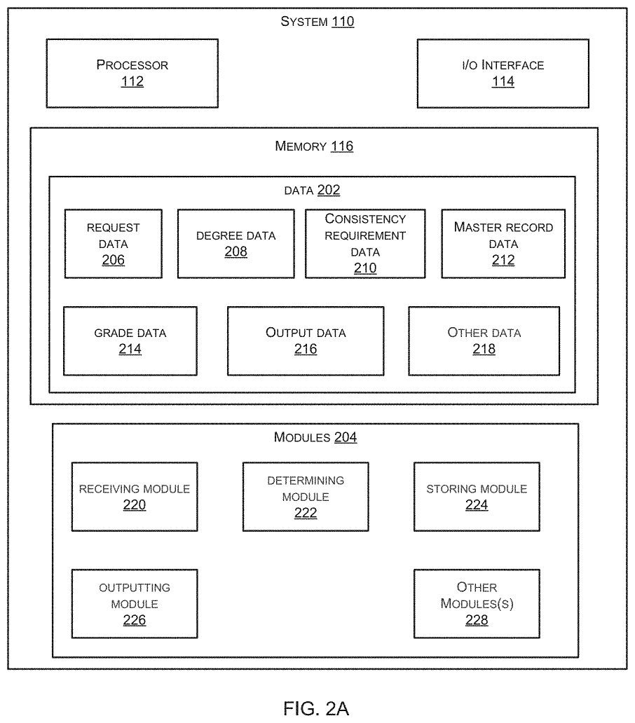

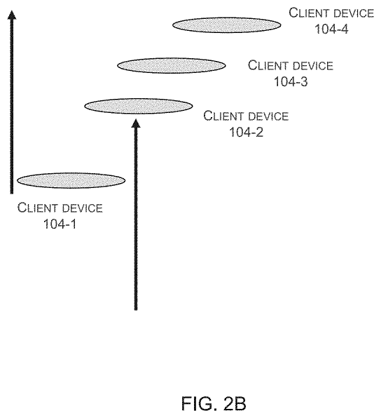

FIG. 2A illustrates a detailed block diagram representation of the proposed system 110, according to embodiments of the present disclosure. The system 110 may include the processor 112, the Input/Output (I/O) interface 114, and the memory 116. In some implementations, the system 110 may include data 202, and modules 204. As an example, the data 202 is stored in the memory 116 configured in the system 110 as shown in the FIG. 2A. In an embodiment, the data 202 may include request data 206, degree data 208, consistency requirement data 210, master record data 212, grade data 214, output data 216, and other data 218. In an embodiment, the data 202 may be stored in the memory 116 in the form of various data structures. Additionally, the data 202 can be organized using data models, such as relational or hierarchical data models. The other data 218 may store data, including temporary data and temporary files, generated by the modules 204 for performing the various functions of the system 110.

In an embodiment, the modules 204, may include a receiving module 220, a determining module 222, a storing module 224, an outputting module 226, and other modules 228.

In an embodiment, the data 202 stored in the memory 116 may be processed by the modules 204 of the system 110. The modules 204 may be stored within the memory 116. In an example, the modules 204 communicatively coupled to the processor 112 configured in the system 110, may also be present outside the memory 116, as shown in FIG. 2A, and implemented as hardware. As used herein, the term modules refer to an Application-Specific Integrated Circuit (ASIC), an electronic circuit, a processor (shared, dedicated, or group) and memory that execute one or more software or firmware programs, a combinational logic circuit, and/or other suitable components that provide the described functionality.

In an embodiment, the receiving module 220 may receive one or more requests from one or more client devices 104 to store information in the cache memory 122. The one or more requests from one or more client devices 104 may be stores as the request data 206. The one or more requests is received from the one or more client devices 104 via at least one of applications, browsers, platforms, and plugins associated with the one or more client devices 104. Further, the determining module 222 may determine degrees of Service Level Agreement (SLA) and consistency requirement grades in the information received via one or more requests or system configurations. The determined degrees of Service Level Agreement (SLA) and consistency requirement grades in the information may be stored as the degree data 208. Further, the consistency requirements in the information may be stored as the consistency requirement data 210. The information is passed in the request explicitly or derived implicitly based on the system configurations. Further, the storing module 224 may store for one-time in a cache layer of the cache memory 122, the information as a master record, based on determining the degrees of SLA and consistency requirement grades. The information of the master record may be stored as the master record data 212. Storing includes allocating a space in the cache memory 122 for the master record. The consistency requirement including a high consistency grade record includes low TTL for outputting updated information to the one or more client devices 104. The consistency requirement including a lower consistency grade record, or stricter deadline requirements, includes a higher TTL for outputting information for longer to the one or more client devices 104, even though the information is stale.

Further, the storing module 224 may store one or more grades of entries of the information referencing to the master record in different layers of the cache memory 122. The one or more grades of entries of the information referencing to the master record in different layers of the cache memory 122 may be stores as the grade data 214. Each of the one or more grades of entries includes different Time-To-Live (TTL). The master record includes maximum TTL which includes TTLs of the one or more entries. The master record and the one or more entries includes row Identity (ID), value, and the TTL. Thereafter, the outputting module 226 may output the information stored in the master record to the one or more client devices 104, based on the SLA and the consistency requirements. The outputted information stored in the master record may be stored as the output data 216.

### Exemplary Scenario

Embodiments herein may cache same information with different Time to Live (TTLs), and optimize for Central Processing Unit (CPU)/network/memory associated with the client devices 104 while caching same information with different Time to Live (TTLs). Embodiments herein may store master record in the cache at one place of the cache memory 104, then having n more entries, each referring to the master record with a different TTLs as shown in Table 1 below.

TABLE 1

| Row Identity (ID) | Value | TTL |
|---|---|---|
| RECORD123_{MASTER} | {ApiResponse} | Max (TTL |
| | | of all |
| | | configured |
| | | grades) |
| RECORD123_{LOW} | RECORD123_{MASTER} | 10 |
| RECORD123_{MID} | RECORD123_{MASTER} | 100 |
| RECORD123_{HIGH} | RECORD123_{MASTER} | 1000 |

As illustrated in the Table 1, the master record may only be transferred once from the application of the client devices 104 to the cache memory 122, and the master record may be stored only once in the cache layer of the cache memory 122. This reduces CPU/network footprint on application side, and memory footprint on cache side. For instance, solving for users 102 of the client devices 104 with varying levels of consistency and SLA requirements may be shown in FIG. 2B. As illustrated in FIG. 2B, for example, a client device 104-1 cannot afford a high latency, however, the client device 104-1 can afford some level of inconsistency in terms of attributes of items/staleness of data. In contrast, a client device 104-4 may sit on the other end of the spectrum, where the client device 104-4 cannot afford any level of inconsistency, although client device 104-4 may be fine with a higher latency. client device 104-2 and client device 104-3 may sit somewhere in the middle of the client device 104-1 and the client device 104-2. More client devices such as client device 104-5 to client device 104-N (not shown in FIG. 2B) may be added and may be subsequently demanding a stricter SLA with some level of compromised inconsistency. A client device such as the client device 104-4 with high latency can afford to wait longer for the response as shown in Table 2 below. This means, in the event of a cache miss, a live-call can/should be made for the client device 104-4. A client device such as the client devices 104-3, 104-2, 104-1 with low latency may have tighter deadlines. A client device such as the client device 104-1 with a low consistency grade may have a higher probability of hitting the cache memory 122, because the TTL is higher for the client device 104-1, however the client device 104-1 may be served out-of-date data, hence the low consistency as shown in Table 2 below.

TABLE 2

| | | | TTL |
|---|---|---|---|
| Client device | Consistency | Latency | (Seconds) |
| Client device 104-4 | High | High | 10 |
| Client device 104-3 | Medium | Low | 450 |
| Client device 104-2 | Medium | Low | 900 |
| Client device 104-1 | Low | Low | 3600 |

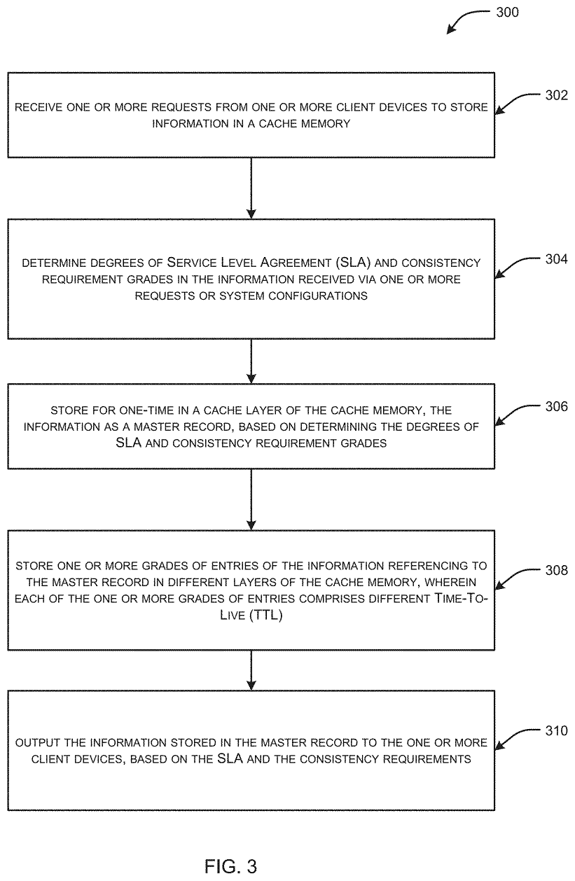

FIG. 3 illustrates a flow chart depicting method 300 of optimizing cached memory comprising varying degrees of Service Level Agreement (SLA) and Consistency Requirement Grades (CRG), according to embodiments of the present disclosure.

At block 302, the method 300 includes, receiving, by the processor 112 associated with the system 110, one or more requests from one or more client devices 104 to store information in the cache memory 122. At block 304, the method 300 includes determining, by the processor 112, degrees of Service Level Agreement (SLA) and consistency requirement grades in the information received via one or more requests or system configurations. At block 306, the method 300 includes storing, by the processor 112, for one-time in a cache layer of the cache memory 122, the information as a master record, based on determining the degrees of SLA and consistency requirement grades. At block 308, the method 300 includes storing, by the processor 122, one or more grades of entries of the information referencing to the master record in different layers of the cache memory 122. Each of the one or more grades of entries comprises different Time-To-Live (TTL). At block 310, the method 300 includes outputting, by the processor 112, the information stored in the master record to the one or more client devices 104, based on the SLA and the consistency requirements.

The order in which the method 300 are described is not intended to be construed as a limitation, and any number of the described method blocks may be combined or otherwise performed in any order to implement the method 300 or an alternate method. Additionally, individual blocks may be deleted from the method 300 without departing from the spirit and scope of the present disclosure described herein. Furthermore, the method 300 may be implemented in any suitable hardware, software, firmware, or a combination thereof, that exists in the related art or that is later developed. The method 300 describe, without limitation, the implementation of the system 110. A person of skill in the art will understand that method 300 may be modified appropriately for implementation in various manners without departing from the scope and spirit of the disclosure.

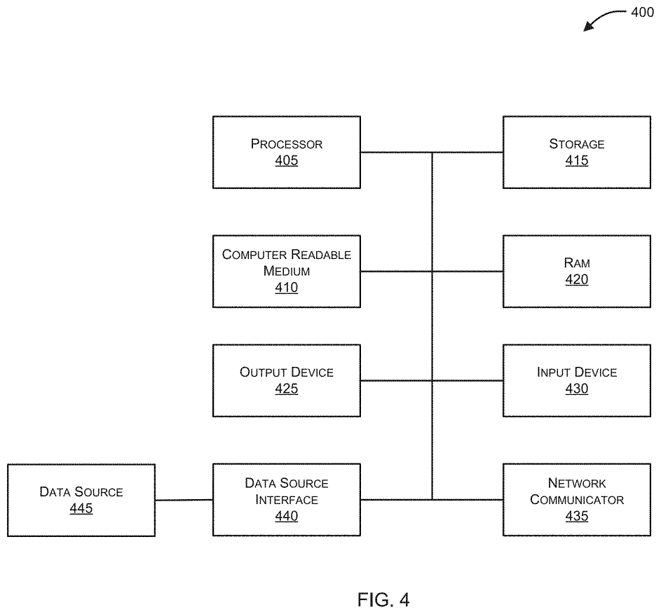

FIG. 4 illustrates a hardware platform 400 for implementation of the disclosed system 110, according to an example embodiment of the present disclosure. For the sake of brevity, construction and operational features of the system 110 which are explained in detail above are not explained in detail herein. Particularly, computing machines such as but not limited to internal/external server clusters, quantum computers, desktops, laptops, smartphones, tablets, and wearables which may be used to execute the system 110 or may include the structure of the hardware platform 400. As illustrated, the hardware platform 400 may include additional components not shown, and that some of the components described may be removed and/or modified. For example, a computer system with multiple GPUs may be located on external-cloud platforms including Amazon® Web Services, or internal corporate cloud computing clusters, or organizational computing resources, etc.

The hardware platform 400 may be a computer system such as the system 110 that may be used with the embodiments described herein. The computer system may represent a computational platform that includes components that may be in a server or another computer system. The computer system may execute, by the processor 405 (e.g., a single or multiple processors) or other hardware processing circuit, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 405 that executes software instructions or code stored on a non-transitory computer-readable storage medium 410 to perform methods of the present disclosure. The software code includes, for example, instructions to gather data and documents and analyze documents. In an example, the modules 204, may be software codes or components performing these steps.

The instructions on the computer-readable storage medium 410 are read and stored the instructions in storage 415 or in random access memory (RAM). The storage 415 may provide a space for keeping static data where at least some instructions could be stored for later execution. The stored instructions may be further compiled to generate other representations of the instructions and dynamically stored in the RAM such as RAM 420. The processor 405 may read instructions from the RAM 420 and perform actions as instructed.

The computer system may further include the output device 425 to provide at least some of the results of the execution as output including, but not limited to, visual information to users, such as external agents. The output device 425 may include a display on computing devices and virtual reality glasses. For example, the display may be a mobile phone screen or a laptop screen. GUIs and/or text may be presented as an output on the display screen. The computer system may further include an input device 430 to provide a user or another device with mechanisms for entering data and/or otherwise interact with the computer system. The input device 430 may include, for example, a keyboard, a keypad, a mouse, or a touchscreen. Each of these output devices 425 and input device 430 may be joined by one or more additional peripherals. For example, the output device 425 may be used to display the results such as bot responses by the executable chatbot.

A network communicator 435 may be provided to connect the computer system to a network and in turn to other devices connected to the network including other clients, servers, data stores, and interfaces, for instance. A network communicator 435 may include, for example, a network adapter such as a LAN adapter or a wireless adapter. The computer system may include a data sources interface 440 to access the data source 445. The data source 445 may be an information resource. As an example, a database of exceptions and rules may be provided as the data source 445. Moreover, knowledge repositories and curated data may be other examples of the data source 445.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### Advantages of the Present Disclosure

The present disclosure provides a system and a method for optimizing cached memory comprising varying degrees of Service Level Agreements (SLA) and Consistency Requirement Grades (CRG).

The present disclosure provides memory optimized cache memory to serve client devices with varying degrees of SLA and consistency requirements (grades).

The present disclosure improves Central Processing Unit (CPU)/network performance of cache memory due to lower data transfer to the external cache memory.

The present disclosure enables the data in cache stored at a single place of the cache memory, considered as the master record, while configured “grades” of cache data have a reference to the master record, and different TTL defined on the cache data.

The present disclosure ensures the data being served cache memory to the client device is fresh, by setting a high consistency grade master record to low Time to Live (TTL).

The present disclosure ensures data is served for longer time, from cache memory to client device with lower consistency requirements, or stricter deadline requirements, even though the data can be stale, by setting a higher TTL to the master record.

The present disclosure helps a microservice cache memory response in an efficient manner for different types of client devices.

We claim:

1. A system for optimizing cached memory comprising varying degrees of Service Level Agreement (SLA) and Consistency Requirement Grades (CRG), the system comprising:
a processor; and
a memory, wherein the memory comprises processor executable instructions, which in execution causes the processor to:
receive one or more requests from one or more client devices to store information in a cache memory;
determine degrees of Service Level Agreement (SLA) and consistency requirement grades in the information received via one or more requests or system configurations;
store for one-time in a cache layer of the cache memory, the information as a master record, based on determining the degrees of SLA and consistency requirement grades;
store one or more grades of entries of the information referencing to the master record in different layers of the cache memory, wherein each of the one or more grades of entries comprises different Time-To-Live (TTL); and
output the information stored in the master record to the one or more client devices, based on the SLA and the consistency requirements.

2. The system as claimed in claim 1, wherein the one or more requests is received from the one or more client devices via at least one of applications, browsers, platforms, and plugins.

3. The system as claimed in claim 1, wherein the master record comprises maximum TTL which includes TTLs of the one or more entries.

4. The system as claimed in claim 1, wherein the consistency requirement comprising a high consistency grade record comprises low TTL for outputting updated information to the one or more client devices.

5. The system as claimed in claim 1, wherein the consistency requirement comprising a lower consistency grade record, or stricter deadline requirements, comprises a higher TTL for outputting information for longer to the one or more client devices, even though the information is stale.

6. The system as claimed in claim 1, wherein the master record and the one or more entries comprises row Identity (ID), value, and the TTL.

7. A method for optimizing cached memory comprising varying degrees of Service Level Agreement (SLA) and Consistency Requirement Grades (CRG), the method comprising:
receiving, by a processor associated with a system, one or more requests from one or more client devices to store information in a cache memory;
determining, by the processor, degrees of Service Level Agreement (SLA) and consistency requirement grades in the information received via one or more requests or system configurations;
storing, by the processor, for one-time in a cache layer of the cache memory, the information as a master record, based on determining the degrees of SLA and consistency requirement grades;
storing, by the processor, one or more grades of entries of the information referencing to the master record in different layers of the cache memory, wherein each of the one or more grades of entries comprises different Time-To-Live (TTL); and
outputting, by the processor, the information stored in the master record to the one or more client devices, based on the SLA and the consistency requirements.

8. The method as claimed in claim 7, wherein the one or more requests is received from the one or more client devices via at least one of applications, browsers, platforms, and plugins.

9. The method as claimed in claim 7, wherein the master record comprises maximum TTL which includes TTLs of the one or more entries.

10. The method as claimed in claim 7, wherein the consistency requirement comprising a high consistency grade record comprises low TTL for outputting updated information to the one or more client devices.

11. The method as claimed in claim 7, wherein the consistency requirement comprising a lower consistency grade record, or stricter deadline requirements, comprises a higher TTL for outputting information for longer to the one or more client devices, even though the information is stale.

12. The method as claimed in claim 7, wherein master record and the one or more entries comprises row Identity (ID), value, and the TTL.
